(19) United States
(12) Patent Application Publication
(10) Pub. No.: US 2025/0293401 A1
(43) Pub. Date: Sep. 18, 2025

(54) CELL STACK

(71) Applicant: TOYOTA JIDOSHA KABUSHIKI KAISHA, Toyota-shi (JP)

(72) Inventors: Takayuki SUGIYAMA, Toyota-shi (JP); Hiroki OHTSUBO, Toyota-shi (JP); Satoshi TABARA, Toyota-shi (JP); Hiroaki IWATA, Toyota-shi (JP); Motokuni MARUHASHI, Toyota-shi (JP); Hiromasa TANAKA, Okazaki-shi (JP); Akio UOTANI, Toyota-shi (JP); Kazuya KUMAZAWA, Toyota-shi (JP)

(73) Assignee: TOYOTA JIDOSHA KABUSHIKI KAISHA, Toyota-shi (JP)

(21) Appl. No.: 19/042,322

(22) Filed: Jan. 31, 2025

(30) Foreign Application Priority Data
Mar. 12, 2024 (JP) 2024-037912

(51) Int. Cl. H01M 50/503; H01M 50/209; H01M 50/507; H01M 50/516

(52) U.S. Cl. CPC H01M 50/503; H01M 50/209; H01M 50/507; H01M 50/516

(57) ABSTRACT

The present disclosure provides a cell stack having a rectangular parallelepiped shape, a plurality of rectangular cells being stacked in the cell stack, and each of the rectangular cells including a terminal provided in an end face thereof in a longitudinal direction. The cell stack includes a plate-like bus bar configured to electrically connect the terminals of the adjacent rectangular cells to each other. The bus bar includes a first slit extending in a stacking direction of the rectangular cell so that at least a part of the first slit overlaps an area that straddles a pair of welded parts welded to the respective terminals of the adjacent rectangular cells, and a second slit extending in parallel with the first slit outside the area that straddles the pair of the welded parts. A width of the first slit is larger than a width of the second slit.

### CROSS REFERENCE TO RELATED APPLICATIONS

This application is based upon and claims the benefit of priority from Japanese patent application No. 2024-037912, filed on Mar. 12, 2024, the disclosure of which is incorporated herein in its entirety by reference.

### BACKGROUND

The present disclosure relates to a cell stack.

In a cell stack according to related art, a terminal is provided on an upper surface of each one of a stack of (hereafter, stacked) rectangular cells. In recent years, as disclosed in Patent Literature 1, a cell stack in which a terminal is provided on an end face of each one of the stacked rectangular cells in the longitudinal direction thereof has been developed.
Patent Literature 1: United States Patent Application Publication No. 2022/0302533

### SUMMARY

The inventors have found the following problem in a cell stack in which a terminal is provided at an end face of each one of the rectangular cells in the cell stack in the longitudinal direction thereof. In this cell stack, a flat plate-like bus bar is welded to each of the respective terminals of the rectangular cells adjacent to each other, whereby the terminals of the adjacent rectangular cells are electrically connected to each other. In, for example, a vehicle-mounted cell stack, stresses repeatedly act on the welded parts of the bus bar due to the vertical movement of a vehicle or the like.

The present disclosure has been made in view of the above-described circumstances, and provides a cell stack that can relieve stresses acting on welded parts of a bus bar and improve fatigue lives of the welded parts.

A cell stack according to an aspect of the present disclosure has a rectangular parallelepiped shape, a plurality of rectangular cells being stacked in the cell stack, and each of the rectangular cells including a terminal provided in an end face thereof in a longitudinal direction,
the cell stack including a plate-like bus bar configured to electrically connect the terminals of the adjacent rectangular cells to each other,
in which the bus bar includes:
a first slit extending in a stacking direction of the rectangular cell so that at least a part of the first slit overlaps an area that straddles a pair of welded parts welded to the respective terminals of the adjacent rectangular cells; and
a second slit extending in parallel with the first slit outside the area that straddles the pair of the welded parts,
in which a width of the first slit is larger than a width of the second slit.

In a cell stack according to the present disclosure, a plate-like bus bar that electrically connects terminals of adjacent rectangular cells to each other includes a first slit extending in a stacking direction of the rectangular cell so that at least a part of the first slit overlaps an area that straddles a pair of welded parts welded to the respective terminals of the adjacent rectangular cells, and a second slit extending in parallel with the first slit outside the area that straddles the pair of the welded parts. Further, a width of the first slit is larger than a width of the second slit.

By the above structure, stresses acting on the welded parts of the bus bar can be relieved, and fatigue lives of the welded parts can be improved.

The second slit may be longer than the first slit. By the above structure, stresses acting on the welded parts of the bus bar can be further relieved, and fatigue lives of the welded parts can be further improved.

The cell stack may further include a third slit disposed so as to face the second slit through the first slit and extending in parallel with the first slit, in which a width of the third slit may be smaller than the width of the first slit. By the above structure, stresses acting on the welded parts of the bus bar can be further relieved while suppressing heat generated when the bus bar is energized, and fatigue strengths of the welded parts can be further improved.

The third slit may be longer than the first slit. By the above structure, stresses acting on the welded parts of the bus bar can be further relieved, and fatigue strengths of the welded parts can be further improved.

The width of the third slit may be the same as the width of the second slit. The above structure makes it easy to form a slit in the bus bar.

The bus bar has a hat-shaped cross section and may protrude outward from between the pair of the welded parts. By the above structure, stresses acting on the welded parts of the bus bar can be further relieved, and fatigue lives of the welded parts can be further improved.

According to the present disclosure, it is possible to provide a cell stack that can relieve stresses acting on welded parts of a bus bar and improve fatigue lives of the welded parts.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a cell stack according to a first embodiment;

FIG. 2 is a perspective view showing the cell stack according to the first embodiment;

FIG. 3 is a plan view of a bus bar B1;

FIG. 4 is a cross-sectional view taken along a cutting line IV-IV of FIG. 3;

FIG. 5 is a plan view of a bus bar B101 according to a comparative example;

FIG. 6 is a plan view of the bus bar B1 according to a first modified example;

FIG. 7 is a plan view of the bus bar B1 according to a second modified example; and

FIG. 8 is a plan view of the bus bar B1 according to a third modified example.

### DESCRIPTION OF EMBODIMENTS

Specific embodiments according to the present disclosure will be described hereinafter in detail with reference to the drawings. However, the present disclosure is not limited to the following embodiments. Further, for the clarification of the description, the following descriptions and the drawings are simplified as appropriate.

### First Embodiment

### <Structure of Cell Stack>

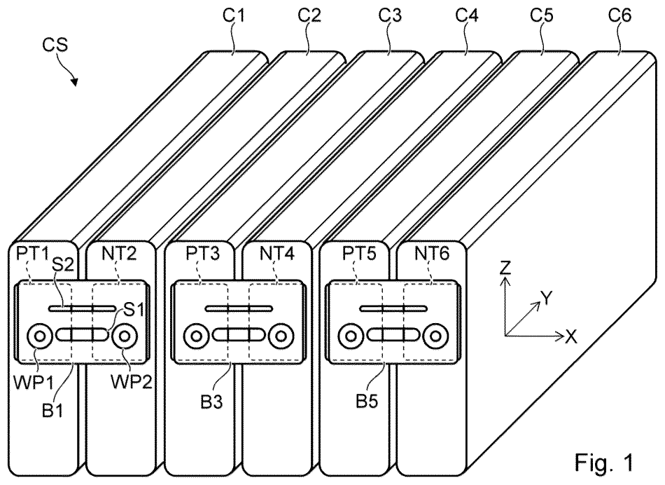

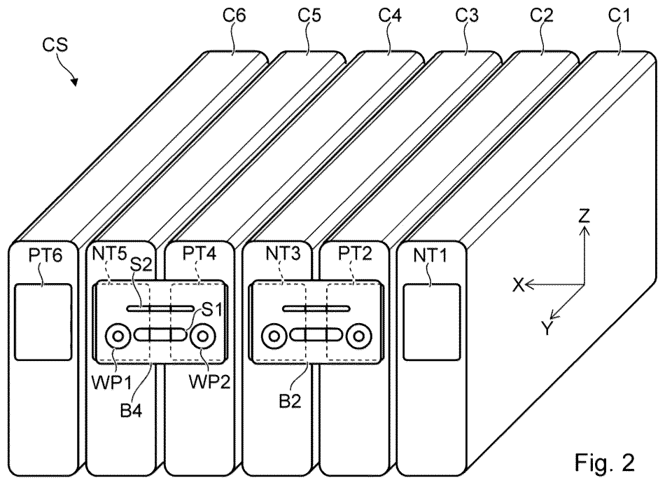

First, a structure of a cell stack according to a first embodiment will be described with reference to FIGS. 1 and 2. Each of FIGS. 1 and 2 is a perspective view showing the cell stack according to the first embodiment.

Note that it is needless to say that right-handed XYZ orthogonal coordinates shown in FIGS. 1 and 2 and other drawings are shown only for the sake of convenience to explain positional relations among the components. Normally, in FIGS. 1 and 2 etc., the Z-axis positive direction is a vertically upward direction, and the XY plane is a horizontal plane, which direction and plane are the same throughout the drawings.

As shown in FIGS. 1 and 2, a cell stack CS according to this embodiment includes rectangular cells C1 to C6 and bus bars B1 to B5.

The cell stack CS according to this embodiment is used, for example, in a vehicle-mounted battery. A vehicle on which the cell stack CS according to this embodiment is mounted is not limited to a particular type of a vehicle; for example, the vehicle is one that can be driven by electric power supplied from the cell stack CS, such as a battery electric vehicle, a hybrid electric vehicle, and a fuel cell electric vehicle.

As shown in FIGS. 1 and 2, the rectangular cells C1 to C6 are rectangular parallelepiped rectangular cells extending in the Y-axis direction. The rectangular cells C1 to C6 are stacked in a thickness direction (the X-axis direction), to thereby form the cell stack CS. The rectangular cells C1 to C6 are, for example, secondary batteries such as lithium-ion batteries and nickel-metal hydride batteries.

Note that, in FIGS. 1 and 2, the cell stack CS is shown in a simplified manner. Although the cell stack CS shown in FIGS. 1 and 2 is formed of six of the rectangular cells C1 to C6, it is usually formed of more rectangular cells. In fact, the number of rectangular cells forming the cell stack CS is not limited to any particular number, and may be any number of two or more. Further, a heat insulating plate, a spacer for adjusting an interval, or the like (not shown) may be inserted between the adjacent rectangular cells.

As shown in FIG. 1, a positive electrode terminal PT1 is provided on one end face (an end face on the Y-axis negative side) of the rectangular cell C1 in the longitudinal direction thereof. The positive electrode terminal PT1 shown in FIG. 1 has a rectangular shape in the XZ plan view and is provided so as to protrude outward from the end face of the rectangular cell C1. However, the present disclosure is not particularly limited thereto. Further, the positive electrode terminal PT1 shown in FIG. 1 is provided on the upper side (the Z-axis positive side) of the end face of the rectangular cell C1. The positive electrode terminal PT1 is made of, for example, a metal material such as copper having excellent electrical conductivity.

Similarly, as shown in FIG. 1, a negative electrode terminal NT2 is provided on one end face (an end face on the Y-axis negative side) of the rectangular cell C2 adjacent to the rectangular cell C1 in the longitudinal direction thereof. A positive electrode terminal PT3 is provided on one end face (an end face on the Y-axis negative side) of the rectangular cell C3 adjacent to the rectangular cell C2 in the longitudinal direction thereof. A negative electrode terminal NT4 is provided on one end face (an end face on the Y-axis negative side) of the rectangular cell C4 adjacent to the rectangular cell C3 in the longitudinal direction thereof. A positive electrode terminal PT5 is provided on one end face (an end face on the Y-axis negative side) of the rectangular cell C5 adjacent to the rectangular cell C4 in the longitudinal direction thereof. A negative electrode terminal NT6 is provided on one end surface (an end face on the Y-axis negative side) of the rectangular cell C6 adjacent to the rectangular cell C5 in the longitudinal direction thereof.

As shown in FIG. 1, each of the negative electrode terminal NT2 of the rectangular cell C2, the positive electrode terminal PT3 of the rectangular cell C3, the negative electrode terminal NT4 of the rectangular cell C4, the positive electrode terminal PT5 of the rectangular cell C5, and the negative electrode terminal NT6 of the rectangular cell C6 has a shape similar to that of the positive electrode terminal PT1 of the rectangular cell C1, and they are disposed in a manner similar to that in which the positive electrode terminal PT1 of the rectangular cell C1 is disposed.

Further, as shown in FIG. 1, the positive electrode terminal PT1 of the rectangular cell C1 and the negative electrode terminal NT2 of the rectangular cell C2, which are disposed so as to be adjacent to each other, are electrically connected to each other by the plate-like bus bar B1. Similarly, the positive electrode terminal PT3 of the rectangular cell C3 and the negative electrode terminal NT4 of the rectangular cell C4, which are disposed so as to be adjacent to each other, are electrically connected to each other by the bus bar B3 of plate-like. Similarly, the positive electrode terminal PT5 of the rectangular cell C5 and the negative electrode terminal NT6 of the rectangular cell C6, which are disposed so as to be adjacent to each other, are electrically connected by the plate-like bus bar B5.

Meanwhile, as shown in FIG. 2, a negative electrode terminal NT1 is provided on the other end face (an end face on the Y-axis positive side) of the rectangular cell C1 in the longitudinal direction thereof. Like the positive electrode terminal PT1 shown in FIG. 1, the negative electrode terminal NT1 shown in FIG. 2 has a rectangular shape in the XZ plan view and is provided so as to protrude outward from the end face of the rectangular cell C1. However, the present disclosure is not particularly limited thereto. Further, like the positive electrode terminal PT1 shown in FIG. 1, the negative electrode terminal NT1 shown in FIG. 2 is provided on the upper side (the Z-axis positive side) of the end face of the rectangular cell C1. Like the positive electrode terminal PT1, the negative electrode terminal NT1 is made of a metal material such as copper having excellent electrical conductivity.

Similarly, as shown in FIG. 2, a positive electrode terminal PT2 is provided on the other end face (an end face on the Y-axis positive side) of the rectangular cell C2 adjacent to the rectangular cell C1 in the longitudinal direction thereof. A negative electrode terminal NT3 is provided on the other end face (an end face on the Y-axis positive side) of the rectangular cell C3 adjacent to the rectangular cell C2 in the longitudinal direction thereof. A positive electrode terminal PT4 is provided on the other end face (an end face on the Y-axis positive side) of the rectangular cell C4 adjacent to the rectangular cell C3 in the longitudinal direction thereof. A negative electrode terminal NT5 is provided on the other end face (an end face on the Y-axis positive side) of the rectangular cell C5 adjacent to the rectangular cell C4 in the longitudinal direction thereof. A positive electrode terminal PT6 is provided on the other end face (an end face on the Y-axis positive side) of the rectangular cell C6 adjacent to the rectangular cell C5 in the longitudinal direction thereof.

As shown in FIG. 2, each of the positive electrode terminal PT2 of the rectangular cell C2, the negative electrode terminal NT3 of the rectangular cell C3, the positive electrode terminal PT4 of the rectangular cell C4, the negative electrode terminal NT5 of the rectangular cell C5, and the positive electrode terminal PT6 of the rectangular cell C6 has a shape similar to that of the negative electrode terminal NT1 of the rectangular cell C1, and they are disposed in a manner similar to that in which the negative electrode terminal NT1 of the rectangular cell C1 is disposed.

Further, as shown in FIG. 2, the positive electrode terminal PT2 of the rectangular cell C2 and the negative electrode terminal NT3 of the rectangular cell C3, which are disposed so as to be adjacent to each other, are electrically connected to each other by the plate-like bus bar B2. Similarly, the positive electrode terminal PT4 of the rectangular cell C4 and the negative electrode terminal NT5 of the rectangular cell C5, which are disposed so as to be adjacent to each other, are electrically connected to each other by the plate-like bus bar B4. As described above, in the cell stack CS shown in FIGS. 1 and 2, the rectangular cells C1 to C6 are connected to each other in series by the bus bars B1 to B5.

Note that the negative electrode terminal NT1 of the rectangular cell C1 shown in FIG. 2 is connected to the positive electrode terminal of another cell stack through, for example, a bus bar (not shown). However, the present disclosure is not particularly limited thereto. Further, the positive electrode terminal PT6 of the rectangular cell C6 shown in FIG. 2 is connected to the negative electrode terminal of yet another cell stack through, for example, a bus bar (not shown). However, the present disclosure is not particularly limited thereto. By the above structure, for example, a plurality of cell stacks can be connected to each other in series.

Since the bus bars B1 to B5 shown in FIGS. 1 and 2 have structures similar to each other, the bus bar B1 will be described.

As shown in FIG. 1, the bus bar B1 is a plate-like member that electrically connects the positive electrode terminal PT1 of the rectangular cell C1 to the negative electrode terminal NT2 of the rectangular cell C2 which are disposed so as to be adjacent to each other. The bus bar B1 is made of, for example, a metal material such as copper having excellent electrical conductivity.

As shown in FIG. 1, the bus bar B1 includes a pair of welded parts WP1 and WP2 respectively welded to the positive electrode terminal PT1 of the rectangular cell C1 and the negative electrode terminal NT2 of the rectangular cell C2 which are disposed so as to be adjacent to each other. The bus bar B1 includes a first slit S1 extending in a stacking direction (the X-axis direction) so that it overlaps an area that straddles the pair of the welded parts WP1 and WP2, and a second slit S2 extending in parallel with the first slit S1 outside the area that straddles the pair of the welded parts WP1 and WP2. Note that a width of the first slit S1 is larger than a width of the second slit S2.

As described above, in the cell stack CS according to this embodiment, the width of the first slit S1 formed so as to overlap the area that straddles the pair of the welded parts WP1 and WP2 is made larger than the width of the second slit S2 formed outside the area that straddles the pair of the welded parts WP1 and WP2. Therefore, stresses acting on the welded parts WP1 and WP2 of the bus bar B1 are relieved, and fatigue lives of the welded parts WP1 and WP2 are improved.

### <Detailed Structure of Bus Bar>

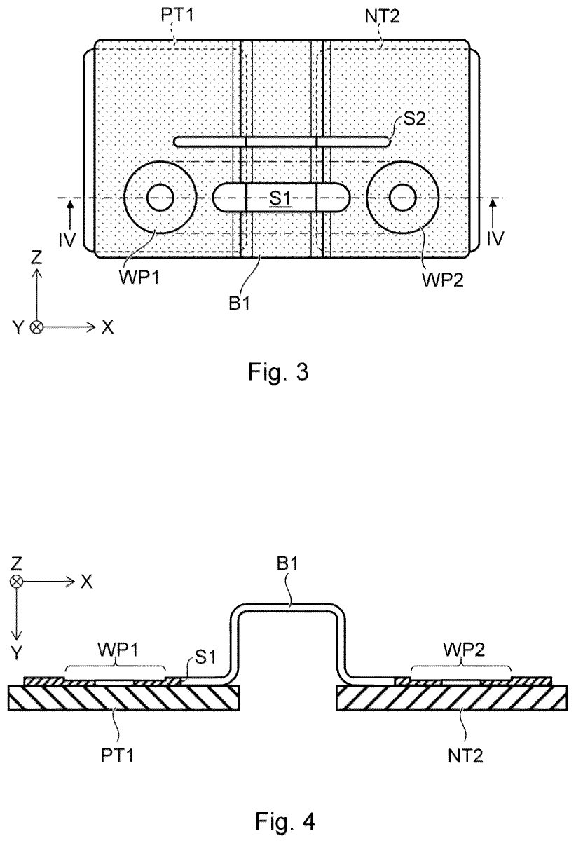

A detailed structure of the bus bar B1 will be described below with reference to FIGS. 3 and 4. FIG. 3 is a plan view of the bus bar B1. FIG. 4 is a cross-sectional view taken along a cutting line IV-IV line of FIG. 3.

Note that FIGS. 3 and 4 also show the positive electrode terminal PT1 of the rectangular cell C1 and the negative electrode terminal NT2 of the rectangular cell C2. Further, although FIG. 3 is a plan view, the bus bar B1 is indicated by a dotted pattern in order to make it easier to understand it.

As shown in FIG. 3, the bus bar B1 is a plate-like member having a rectangular shape in the XZ plan view. The bus bar B1 is provided so as to cover substantially the entire positive electrode terminal PT1 of the rectangular cell C1 and the entire negative electrode terminal NT2 of the rectangular cell C2. As described above, the bus bar B1 includes a pair of the welded parts WP1 and WP2 respectively welded to the positive electrode terminal PT1 of the rectangular cell C1 and the negative electrode terminal NT2 of the rectangular cell C2 which are disposed so as to be adjacent to each other.

Note that FIGS. 3 and 4 show the welded parts WP1 and WP2 before they are welded. The bus bar B1 is welded to the positive electrode terminal PT1 of the rectangular cell C1 in the welded part WP1, for example, by irradiating the welded part WP1 with a laser beam from the Y-axis negative side. However, the present disclosure is not particularly limited thereto. Similarly, the bus bar B1 is welded to the negative electrode terminal NT2 of the rectangular cell C2 in the welded part WP2 by irradiating the welded part WP2 with a laser beam from the Y-axis negative side.

The welded parts WP1 and WP2 shown in FIG. 3 are provided at respective ends of the bus bar B1 on the lower side thereof (the Z-axis negative side) in the X-axis direction. However, the present disclosure is not particularly limited thereto. Each of the welded parts WP1 and WP2 shown in FIGS. 3 and 4 has a circular shape in the XZ plan view and includes a through hole in the center thereof. However, the present disclosure is not particularly limited thereto. Further, as shown in FIG. 4, each of the welded parts WP1 and WP2 is counterbored, and has a plate thickness smaller than the thicknesses of other areas of the bus bar B1.

Note that, as shown in FIG. 3, the first slit S1 extends in the stacking direction (the X-axis direction) inside an area that straddles a pair of the welded parts WP1 and WP2. Further, the second slit S2 extends in parallel with the first slit S1 outside the area that straddles the pair of the welded parts WP1 and WP2. Note that the width of the first slit S1 is larger than the width of the second slit S2.

Note that, in FIG. 3, the area that straddles the pair of the welded parts WP1 and WP2 is an area surrounded by circles that define the outer edges of the pair of the welded parts WP1 and WP2 and a pair of dashed lines that connect the circles to each other. The first slit S1 is not limited to being formed inside the area that straddles the pair of the welded parts WP1 and WP2, and may be formed so that at least a part of the first slit S1 overlaps the area that straddles the pair of the welded parts WP1 and WP2.

On the other hand, as shown in FIG. 3, the second slit S2 is formed so that it does not overlap the area that straddles the pair of the welded parts WP1 and WP2.

Note that the respective sizes of the pair of the welded parts WP1 and WP2 may be different, and the welded parts WP1 and WP2 may be formed so that their respective positions relative to each other are shifted as viewed from the X-axis direction.

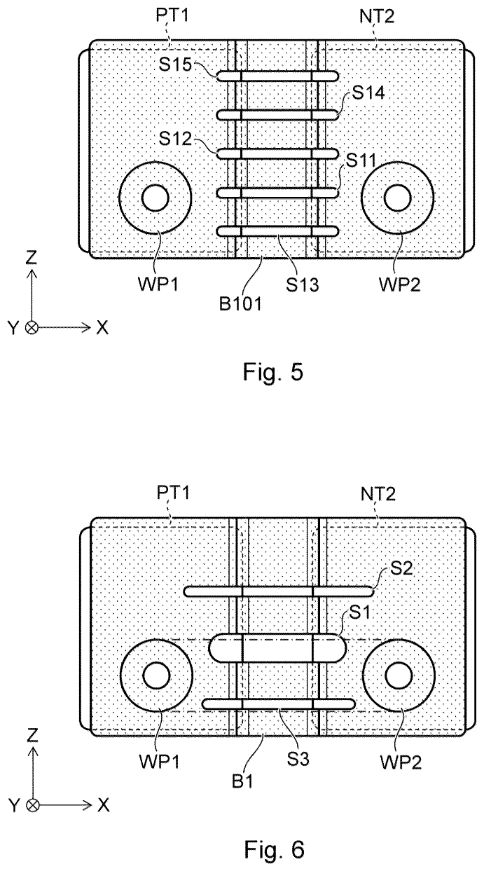

FIG. 5 is a plan view of a bus bar B101 according to a comparative example. As shown in FIG. 5, the bus bar B101 according to the comparative example includes a pair of the welded parts WP1 and WP2 and five slits S11 to S15. The first slit S11 shown in FIG. 5 corresponds to the first slit S1 shown in FIG. 3 and extends in a stacking direction (the X-axis direction) inside an area that straddles the pair of the welded parts WP1 and WP2. The second slit S12 shown in FIG. 5 extends in parallel with the first slit S11 outside the area that straddles the pair of the welded parts WP1 and WP2.

Further, the bus bar B101 according to the comparative example includes the third slit S13 disposed so as to face the second slit S12 through the first slit S11 and extending in parallel with the first slit S11. Further, the bus bar B101 according to the comparative example includes the fourth slit S14 and the fifth slit S15 disposed so as to face the first slit S11 through the second slit S12 and extending in parallel with the second slit S12.

As shown in FIG. 5, the five slits S11 to S15 formed in the bus bar B101 according to the comparative example have the same length and width.

Thus, although the bus bar B101 according to the comparative example includes a plurality of slits extending in the stacking direction (the X-axis direction) and having the same width, stresses acting on the pair of the welded parts WP1 and WP2 cannot be sufficiently relieved.

On the other hand, in the cell stack CS according to this embodiment, as shown in FIG. 3, the width of the first slit S1 formed so as to overlap the area that straddles the pair of the welded parts WP1 and WP2 is made larger than the width of the second slit S2 formed outside the area that straddles the pair of the welded parts WP1 and WP2. That is, the width of the first slit S1 shown in FIG. 3 is made larger than the width of the first slit S11 in the bus bar B101 according to the comparative example shown in FIG. 5.

By the above structure, in the cell stack CS according to this embodiment, stresses acting on the welded parts WP1 and WP2 of the bus bar B1 are more relieved than are the stresses acting on the welded parts WP1 and WP2 of the bus bar B101 according to the comparative example shown in FIG. 5, and fatigue lives of the welded parts WP1 and WP2 are more improved than are the fatigue lives of the welded parts in the bus bar B101 according to the comparative example shown in FIG. 5.

Note that the first slit S1 shown in FIG. 3 is longer than the first slit S11 in the bus bar B101 according to the comparative example shown in FIG. 5.

Further, as shown in FIG. 3, the second slit S2 is longer than the first slit S1, and the second slit S2 is formed so as to overlap the welded parts WP1 and WP2 as viewed from the Z-axis direction. That is, the second slit S2 shown in FIG. 3 is made longer than the second slit S12 in the bus bar B101 according to the comparative example shown in FIG. 5. By this structure, in the bus bar B1 shown in FIG. 3, stresses acting on the welded parts WP1 and WP2 of the bus bar B1 can be more relieved than are the stresses acting on the welded parts WP1 and WP2 of the bus bar B101 according to the comparative example shown in FIG. 5.

Further, in the bus bar B1 shown in FIG. 3, the number of slits required is smaller than the number of slits required in the bus bar B101 according to the comparative example shown in FIG. 5, and the part of the area of the bus bar B1 occupied by the first slit S1 and the second slit S2 is smaller than the part of the area of the bus bar B101 occupied by the slits S11 to S15 according to the comparative example shown in FIG. 5. Therefore, in the bus bar B1 shown in FIG. 3, as compared with the bus bar B101 according to the comparative example shown in FIG. 5, an increase in resistance due to the formation of a slit can be reduced and heat generated when the bus bar B1 is energized can be suppressed.

Further, as shown in FIG. 4, the bus bar B1 according to this embodiment has a hat shape in the XY section, and protrudes outward (on the Y-axis negative side) from between the pair of the welded parts WP1 and WP2. Therefore, stresses acting on the welded parts WP1 and WP2 of the bus bar B1 having the hat shape can be more relieved than in a case where the bus bar B1 has a simple flat plate shape.

Note that the cross-sectional shape of the bus bar B1 is not limited to a hat shape, and may be, for example, a simple flat plate shape.

As described above, in the cell stack CS according to this embodiment, the width of the first slit S1 formed so as to overlap the area that straddles the pair of the welded parts WP1 and WP2 is made larger than the width of the second slit S2 formed outside the area that straddles the pair of the welded parts WP1 and WP2. Therefore, stresses acting on the welded parts WP1 and WP2 of the bus bar B1 are relieved, and fatigue lives of the welded parts WP1 and WP2 are improved.

### First Modified Example

Next, the bus bar B1 according to a first modified example will be described with reference to FIG. 6. FIG. 6 is a plan view of the bus bar B1 according to the first modified example.

As shown in FIG. 6, as compared with the bus bar B1 shown in FIG. 3, the bus bar B1 according to the first modified example further includes a third slit S3 disposed so as to face the second slit S2 through the first slit S1 and extending in parallel with the first slit S1.

The third slit S3 shown in FIG. 6 corresponds to the third slit S13 in the bus bar B101 according to the comparative example shown in FIG. 5. Note that the third slit S3 shown in FIG. 6 is longer than the third slit S13 in the bus bar B101 according to the comparative example shown in FIG. 5.

The third slit S3 shown in FIG. 6 is formed between a pair of the welded parts WP1 and WP2. However, the present disclosure is not particularly limited thereto. Note that the width of the third slit S3 is the same as the width of the second slit S2 and smaller than the width of the first slit S1. By providing the third slit S3 having a width smaller than that of the first slit S1, stresses acting on the welded parts WP1 and WP2 of the bus bar B1 can be further relieved while suppressing heat generated due to an increase in resistance. Further, by making the width of the third slit S3 the same as the width of the second slit S2, it becomes easy to form a slit in the bus bar B1.

Further, as shown in FIG. 6, by making the third slit S3 longer than the first slit S1, stresses acting on the welded parts WP1 and WP2 of the bus bar B1 can be further relieved.

Note that, as shown in FIG. 6, the first slit S1 may be formed so as to protrude from an area that straddles the pair of the welded parts WP1 and WP2.

As described above, the bus bar B1 according to the first modified example includes the third slit S3 having a width smaller than that of the first slit S1. Therefore, stresses acting on the welded parts WP1 and WP2 of the bus bar B1 can be more relieved than are the stresses acting on the welded parts WP1 and WP2 of the bus bar B1 shown in FIG. 3 while suppressing heat generated due to an increase in resistance.

The structures other than the above ones are similar to those of the bus bar B1 shown in FIGS. 3 and 4, and the descriptions thereof will thus be omitted.

### Other Modified Examples

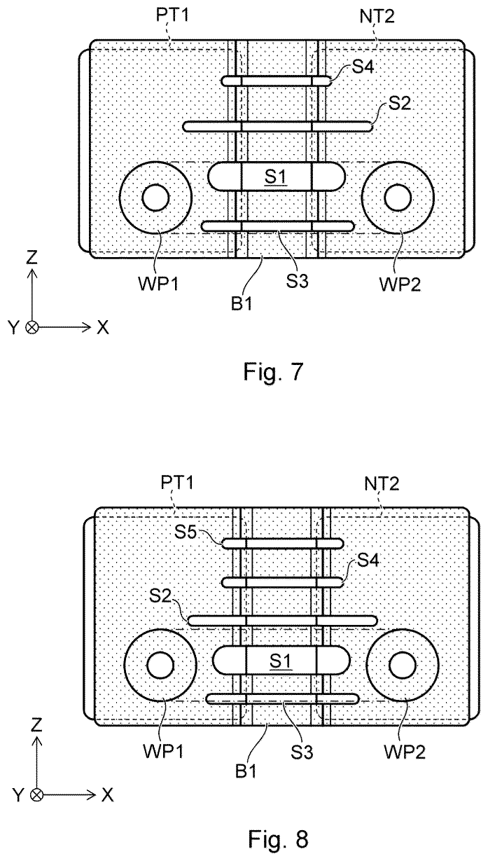

Next, the bus bar B1 according to other modified examples will be described with reference to FIGS. 7 and 8. FIG. 7 is a plan view of the bus bar B1 according to a second modified example. FIG. 8 is a plan view of the bus bar B1 according to a third modified example.

As shown in FIG. 7, as compared with the bus bar B1 according to the first modified example shown in FIG. 6, the bus bar B1 according to the second modified example further includes a fourth slit S4 disposed so as to face the first slit S1 through the second slit S2 and extending in parallel with the second slit S2.

Note that the fourth slit S4 shown in FIG. 7 corresponds to the fourth slit S14 in the bus bar B101 according to the comparative example shown in FIG. 5. The fourth slit S4 shown in FIG. 7 has the same shape as that of the fourth slit S14 in the bus bar B101 according to the comparative example shown in FIG. 5. However, the present disclosure is not particularly limited thereto.

Further, as shown in FIG. 8, as compared with the bus bar B1 according to the first modified example shown in FIG. 6, the bus bar B1 according to the third modified example further includes the fourth slit S4 and a fifth slit S5 disposed so as to face the first slit S1 through the second slit S2 and extending in parallel with the second slit S2.

Note that the fourth slit S4 and the fifth slit S5 shown in FIG. 8 correspond to the fourth slit S14 and the fifth slit S15 in the bus bar B101 according to the comparative example shown in FIG. 5. The shapes of the fourth slit S4 and the fifth slit S5 in the bus bar B1 shown in FIG. 8 are the same as those of the fourth slit S14 and the fifth slit S15 in the bus bar B101 according to the comparative example shown in FIG. 5. However, the present disclosure is not particularly limited thereto.

As shown in FIGS. 7 and 8, a slit may be further added to the bus bar B1 according to the first modified example shown in FIG. 6. By this structure, stresses acting on the welded parts WP1 and WP2 of the bus bar B1 can be more relieved than are the stresses acting on the welded parts WP1 and WP2 of the bus bar B1 according to the first modified example shown in FIG. 6. Meanwhile, by further adding a slit to the bus bar B1, the resistance of the bus bar B1 becomes larger than that of the bus bar B1 according to the first modified example shown in FIG. 6.

The structures other than the above ones are similar to those of the bus bar B1 according to the first modified example shown in FIG. 6, and the descriptions thereof will thus be omitted.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A cell stack having a rectangular parallelepiped shape, a plurality of rectangular cells being stacked in the cell stack, and each of the rectangular cells comprising a terminal provided in an end face thereof in a longitudinal direction,
the cell stack comprising a plate-like bus bar configured to electrically connect the terminals of the adjacent rectangular cells to each other,
wherein the bus bar comprises:
a first slit extending in a stacking direction of the rectangular cell so that at least a part of the first slit overlaps an area that straddles a pair of welded parts welded to the respective terminals of the adjacent rectangular cells; and
a second slit extending in parallel with the first slit outside the area that straddles the pair of the welded parts,
wherein a width of the first slit is larger than a width of the second slit.

2. The cell stack according to claim 1, wherein the second slit is longer than the first slit.

3. The cell stack according to claim 1, further comprising a third slit disposed so as to face the second slit through the first slit and extending in parallel with the first slit,
wherein a width of the third slit is smaller than the width of the first slit.

4. The cell stack according to claim 3, wherein the third slit is longer than the first slit.

5. The cell stack according to claim 3, wherein the width of the third slit is the same as the width of the second slit.

6. The cell stack according to claim 1, wherein the bus bar has a hat-shaped cross section and protrudes outward from between the pair of the welded parts.
